(19) United States
(12) Patent Application Publication
(10) Pub. No.: US 2009/0307098 A1
(43) Pub. Date: Dec. 10, 2009

(54) FIXED PRICE FUEL METHOD

(76) Inventor: Steven N. Verona, Philadelphia, PA (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 12/478,948

(22) Filed: Jun. 5, 2009

Related U.S. Application Data
(60) Provisional application No. 61/058,973, filed on Jun. 5, 2008.

(51) Int. Cl. G06Q 50/00; G06Q 20/00; G06Q 30/00; G06Q 10/00

(52) U.S. Cl. 705/17; 705/39; 705/41; 705/26; 705/30; 222/1; 235/381

(57) ABSTRACT

A method and apparatus for a customer pre-purchasing goods, such as liquid fuel, from an entity and taking possession of the goods at a later time. Fuel is dispensed at a fuel-dispensing facility operated by a third party. The customer pre-purchases the fuel, such as by transmitting money to the entity. The entity sends evidence of the pre-purchase to the customer. The customer presents the evidence of the pre-purchase to the third party. The evidence verifies the customer's right to the fuel. The third party verifies the evidence and then permits the customer to dispense the fuel, such as into a fuel tank. The entity then transmits to the third party a second amount of money related to the amount of fuel dispensed. The second amount of money is substantially equal to a value of the dispensed fuel at the second time.

### CROSS-REFERENCES TO RELATED APPLICATIONS

This application claims the benefit of U.S. Provisional Application No. 61/058,973 filed Jun. 5, 2008, which is incorporated herein by reference.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to methods and apparatuses for purchasing goods and/or services and taking delivery of the goods and/or services at a later time.

2. Description of the Related Art

It is well known to purchase goods at one point in time, and take delivery at that time, such as when buying goods in a retail store. It is also known to take delivery of the goods at a time later than the time of purchase. This can be accomplished, such as by ordering and paying for goods shown in a catalog or on a web site, and taking delivery of the goods as soon as the goods can be shipped or otherwise transported to the purchaser. However, when one orders goods in this manner, there is no certainty in the date of delivery, and once the goods arrive, they have to be stored. Thus, if a person wishes to pre-purchase goods in order to avoid a price increase or an anticipated shortage, that person has to store the goods until the goods are consumed.

Some goods cannot be stored for long periods of time, such as perishable foods and volatile chemicals. For example, very few persons have the physical space to store sufficient food or fuel for their personal needs during an average year. Even if storage is possible, fresh foods and some fuels change over a long period of time, which makes storage unfeasible. Therefore, consumers are forced to purchase such goods essentially as often as the goods are needed, thereby subjecting consumers to the variations in the market price of the goods at any time. Such variations can be due to normal market forces, but they are also subject to manipulation due to unscrupulous, near-monopolistic providers of goods combined with inelastic demand for the goods.

There is therefore a need for a method and apparatus that enables consumers to pre-purchase fuel and other goods or services, but avoids the requirement of taking delivery of the goods or services until a time that the consumer needs to consume them.

### BRIEF SUMMARY OF THE INVENTION

The invention includes a method of providing consumers of fuel, such as gasoline, diesel, and any alternative fuels (biofuels, ethanol, ethanol/gasoline mixtures, etc.), the ability to pre-purchase fuel at a fixed price and take delivery of the fuel at any time after the time of purchase of the fuel. The method does not require the consumer to store the pre-purchased fuel or otherwise maintain the fuel in any way. The fuel is stored in the manner fuel is normally stored by people who normally store fuel, but is pre-purchased for future delivery at substantially the cost of fuel at the time of pre-purchase.

The invention is contemplated to include the following steps: First, the pre-purchase customer purchases fuel at a first time by transmitting funds to an entity, at a rate specific to the geographic area in which the customer designates. The entity then sends the pre-purchaser evidence of the pre-purchase. This evidence can be a credit/debit card, a gift card or a card specific to the entity, and has some data or information thereon that can preferably be read by a machine, such as a magnetic strip that can be read by a card scanner. Alternatively, the evidence can be a password, a certificate or any other unique identifier.

At a second time that is later than the first time, the pre-purchaser presents the evidence of the purchase to a fuel seller, such as by swiping the card through a magnetic card reader, which preferably confirms the validity of the card. Of course, this step could alternatively include optical scanners or any other device that can “read” information from a card or other object, and confirm its validity.

If the fuel seller accepts the evidence, which may simply be a card issued by the entity that contains an account number to a valid account, the seller permits the pre-purchaser to dispense an amount of fuel. The amount of fuel can be limited to that amount up to, or greater than, the volume pre-purchased prior to the second time. The fuel seller is paid by the entity for the fuel dispensed by the pre-purchaser. Preferably the fuel seller is paid by the entity according to the current price of fuel (at the second time) without regard to the pre-purchased price (at the first time) of the fuel.

### BRIEF DESCRIPTION OF THE SEVERAL VIEWS OF THE DRAWINGS

FIG. 1 is a schematic side view illustrating one example of an apparatus by which the invention can be carried out.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

In a preferred method, a consumer is presented with a quote for purchasing fuel and can decide how much he or she wishes to pre-purchase for his or her account. The quote is simply a communication of the offered price per unit of fuel, and can come in the form of a web page display, email, text message, telephone conversation (such as telemarketing or the consumer calling to receive a quote), printed document, street sign/billboard, or any other form of communication.

After receiving the quote, if a pre-purchase of fuel at the quoted rate is desired, the consumer carries out a transaction in which the fuel is pre-purchased. The consumer preferably does so in a conventional manner that is quick and convenient, such as using a credit card over the internet or telephone. Of course, any transfer of consideration can be substituted for the preferred method, including but not limited to cash, check, standing account, debit card, electronic funds transfer and PayPal brand electronic transfer.

After the purchase, the consumer receives evidence of the purchase of a particular quantity of fuel and a particular type. The evidence is preferably a credit, debit, or gift card containing conventionally-embedded data on a magnetic strip thereon, or if the consumer already has such a card, the evidence can be information communicating to the consumer that the account of money identified by the card has been replenished with the purchased amount of fuel. Alternatively, the evidence can be a digital certificate, paper certificate, unique password or any other secure mode of providing evidence of the purchase of fuel. The evidence includes at least data indicating that the purchase of fuel occurred, and preferably includes data indicating the amount of fuel purchased or a link (such as a hyperlink or an account number) to such data. Alternatively, the evidence can be the continuation of a valid account card or other such device. That card or other evidence can be presented when the consumer wishes to take delivery of some or all of the fuel pre-purchased, in order, for example, to prove that the holder of the card or evidence is a member of a group, and is entitled to receive the benefits of membership, such as dispensing pre-purchased fuel.

At some time after the consumer pre-purchases the fuel, the consumer takes delivery of the fuel at a fuel dispensing establishment, such as a local fuel station. The consumer preferably merely presents the evidence received to a person or a machine programmed to verify the evidence. In one embodiment, the evidence can be presented by swiping a card with a magnetic strip through a magnetic card reader at a fuel station, such as on a gasoline pump. Alternatively, one can verify the evidence by typing password information into a keypad on the gasoline pump, by a person viewing the evidence and permitting dispensing of fuel by release of a pump, or any other suitable means.

In one example, a consumer who pre-purchased gasoline in January drives his automobile to a fuel station on the first day of the next March. The consumer places a card he received from the company from which he purchased the fuel into a slot on the fuel pump and the pump permits him to dispense the pre-purchased fuel into his automobile's fuel tank. The fuel card that the consumer uses at the pump obligates the company operating the method of the invention, or some intermediary company, to pay the fuel station for the fuel that is pumped. In one example, the evidence presented by the consumer at the fuel station is a valid card, but no information is available to the fuel station regarding the number of gallons of fuel available for dispensing. Instead, the fuel station is paid by the company whose member presents the card, based upon some form of trust between the parties. The company is liable to pay the fuel station if the customer does not keep his obligation to dispense only the amount of fuel that is pre-purchased. However, the company and the member have previously determined the costs to the member of such breach by reaching terms in an account agreement.

In an alternative embodiment, the fuel station is not paid by the company whose member dispensed the pre-purchased fuel, but by the consumer himself or herself. In this situation, the consumer has pre-purchased the fuel at a particular price, for example at A dollars per gallon. When the consumer later dispenses a quantity of fuel into her vehicle's fuel tank, she pays the fuel station for the fuel using a funding source that is not associated with the company from which she pre-purchased the fuel, such as her own credit card, cash or equivalent. After this purchase, the consumer communicates to the company from which she pre-purchased the fuel the date, place and quantity of fuel purchased and paid for herself. The company from which she pre-purchased the fuel subsequently reimburses the consumer an amount of money, such as by wire transfer, for the cost of the purchase. In the preferred method, the amount reimbursed is calculated by multiplying the quantity of fuel purchased by a cost per gallon at the time of the dispensing of fuel. Because the cost per gallon in the company's system may differ from the amount the consumer actually paid, the amount reimbursed may differ from the amount the consumer actually paid to the fuel station, but the difference will not typically be substantial.

According to a second example, the fuel that the consumer pre-purchased from the company, for example 100 gallons, is delivered to the consumer through a conventional fuel filling station when the consumer uses the company's card to verify at the fuel pump that he or she is permitted to obtain fuel from the filling station. The company pays the filling station through a payment network such as Visa, Amex, Voyager, etc. for the fuel delivered to the consumer. In this example, the company that carries out the method of the invention with consumers operates as a large fleet account and the customers/members are part of the fleet. In a preferred embodiment, the pre-purchasing of fuel for an account holder permits the account holder to dispense even more fuel than he or she pre-purchased. This operates in the manner of “overdraft protection”, and is a benefit that members can obtain as part of their membership. A premium can be charged to the member for this service, or the member can simply be invoiced or otherwise charged for the purchase. Alternatively, if the user dispenses too much fuel, the account card can be disabled for use at any later time until more fuel is pre-purchased, at which time the card becomes valid for use again.

The method of the invention has some similarities to existing technology in the area of pre-paid phone card methods. In these methods, such cards contain or can connect to data relating to the pre-purchased amount of time used, but not (or not exclusively) a dollar amount representing the cost of the time pre-purchased for use on a telephone. This is similar to the present invention. However, the method of the present invention differs from the prior art pre-paid phone cards in many other ways. For example, the storage and delivery of a non-physical product, such as “pre-paid minutes” is different than the storage and delivery of a flammable liquid fuel such as gasoline or diesel. And because fuel cannot be stored in significant quantities by the average consumer, unlike minutes on a telephone system, the method of the present invention includes a step of arranging with fuel selling stores to accept the evidence of the pre-purchased fuel in exchange for the delivery of fuel at their tangible filling stations where the fuel is stored.

Fuel prices can vary considerably over a short period of time, whereas telecommunications costs to consumers generally do not, and even have had an overall downward trend in the United States for the past decade or more. Thus, the cost benefit advantage of pre-paid phone cards is not substantial, but the cost benefit advantage of fuel is due to fuel's upward trend. Likewise, the fuel that is purchased must be physically replenished by the fuel seller, whereas minutes on a telephone system do not have to be physically replenished by a telephone system—there are simply as many minutes as the telephone system is able to accommodate. Still further, there are costs for delivery of pre-purchased fuel, but there are no substantial costs to replenish pre-purchased minutes. With the present invention these costs are made to a much larger group of goods/service providers due to the fact that essentially any fuel station will accept the card, whereas there are only a few telephone systems.

Because in one embodiment of the invention the fuel sellers are, in effect, accepting a payment method similar to Visa, Amex, Voyager, etc., there are no special contractual arrangements made with the participating filling stations. If the filling stations accept the payment network, they honor the company's cards, and therefore consumers who pre-purchase fuel can dispense the pre-purchased fuel at that filling station. It is like an MBNA Bank (or any other bank) Visa card where the filling station doesn't need a contractual arrangement with MBNA or any of the other banks that supply Visa cards, the filling station only has a contractual arrangement with Visa.

In a preferred embodiment, the company carrying out the method has a contractual arrangement with Voyager and all stations that accept Voyager accept the company Voyager card from consumers who have pre-purchased fuel. This contractual arrangement can include a clause that the filling stations accept the Voyager card in exchange for a portion of revenues obtained by the person or entity carrying out other steps of the method. Alternatively, the filling station can accept the Voyager card in exchange for increased volume of fuel dispensed at their stations, resulting in increased sales of other goods due to increased customer volume. Of course, any other contractual arrangement can be negotiated that induces such filling station establishments to accept the evidence of pre-purchased fuel, such as a special card, in exchange for the delivery of fuel. The filling stations do not necessarily have to accept special-purpose evidence of the pre-purchased fuel, although this could be the case with one embodiment. In the method disclosed herein, the filling stations are simply accepting a valid membership card as a promise of payment from the company operating the method of the invention. The company is the entity that is obligated to pay on behalf of the consumer dispensing fuel into the vehicle.

A card containing data relating to the fuel purchased does not actually have to contain a running total of fuel remaining, such as by storing in the magnetic strip or other memory device on the card the quantity of pre-purchased fuel remaining. Instead, the card preferably contains unique identifier information (such as an account number, password, etc.) that is associated with data in a database remote from the card that contains a running total for many cards, accounts and/or unique identifiers. This unique identifier information can be used to access the database, such as over the internet, a virtual private network, a telephone line or any other data transmission means, to obtain the information about the amount of fuel that can be dispensed by the consumer. Alternative, the unique identifier can simply be used to verify a valid membership in a group, and thereby permit a fuel pump to dispense fuel.

The method of the present invention includes a step of tracking the gallons (or other units of fuel, preferably by volume or mass) pre-purchased and redeemed when delivery of the fuel is made to the customer who pre-purchased the fuel. It is preferred that the present invention not include a step of tracking the dollar amount spent for the fuel that is visible to the consumer, or the consumer can review, because this is not a necessary step for the invention. Indeed, because the pre-purchased quantity of fuel is made available to the consumer essentially regardless of how much the price per unit of fuel increases, there is no need to keep track of the dollar value of the fuel when it is dispensed. Instead, the amount of fuel dispensed can be seen by the consumer to reduce the amount available to be dispensed by the amount already dispensed, even though the entity might be made aware only of the dollar amount of a sale, which can be converted to quantity of fuel in volume, but the consumer is not made aware of the tracking of dollar amounts being tracked by the entity. Of course, there may be an internal business or other reasons to track the dollar amount of fuel dispensed, such as to track whether the method is making or losing money for the company. However, this is not necessary for the invention, and in the preferred embodiment no tracking of this is made. The dollar amount per unit of fuel changes frequently, and tracking the dollar amount per unit of fuel in this manner is thus not part of the preferred embodiment of the invention.

In the most preferred embodiment, the company carrying out most or all of the steps of the invention calculates an average purchase price of fuel for the geographic region or other market to permit pre-purchases of fuel at that cost, and permit delivery (dispensing) at that cost, too. This can be calculated by polling filling stations within each geographic region, or polling groups of filling stations of a particular brand or ownership, or other subdivisions. It is also preferred to allow deliveries to vary from the cost of the pre-purchase by a particular amount, such as ten cents per gallon, without affecting the amount of fuel that can be delivered. In this scenario, a customer can purchase fuel at the geographic average cost for his area, and then later take delivery of the fuel at the current average, or within a range thereof, and the number of gallons delivered is not affected. If the filling station where he takes delivery has a per-unit cost more than X cents greater than that average, a premium is charged so that less fuel than was pre-purchased is delivered to the customer. Alternatively, if the per-unit cost is X cents below that average, a credit is given and more fuel can be delivered than pre-purchased. Because of this method, a purchaser who pre-purchases fuel at a low-cost fuel area, and moves or travels to a higher cost fuel area where deliveries are taken, is still able to take delivery of the pre-purchased fuel. However, he or she will take delivery of somewhat less fuel than he or she pre-purchased due to the differences in average cost in the two areas.

In an example of the invention, a customer visits a website for the company carrying out most or all of the method, and views a quote to pre-purchase fuel for $3 per gallon in Columbus, Ohio. He chooses to buy 100 gallons at that rate for a total cost of $300, and does so in a conventional manner. In this example, the customer transfers funds to an account, such as by credit card, Paypal, electronic fund transfer, etc. The customer preferably transfers funds into the account of a company offering the fuel for sale. Then the customer receives evidence of the purchase of a certain quantity of fuel, which is the maintenance of a valid account card for taking delivery of fuel. In a preferred embodiment, the evidence indicates the running total gallons pre-purchased on an account, and the receipt of funds transferred to the company by the customer results in the addition of a certain amount of fuel to the customer's account, which can be accessed by using the re-usable card bearing a magnetic strip.

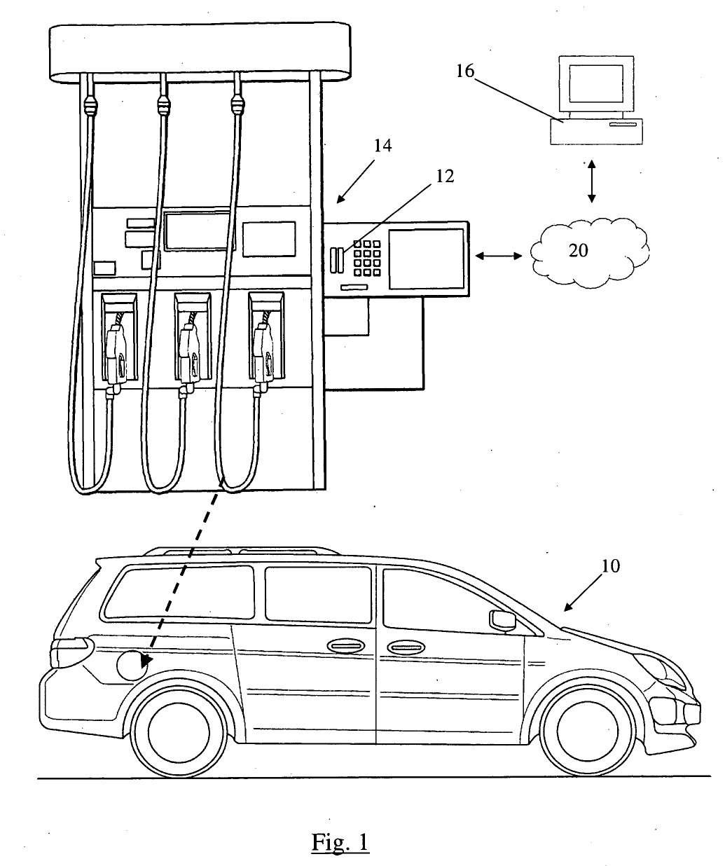

The customer later travels to a local filling station, as shown in FIG. 1, where he wants to pump 10 gallons of fuel into his automobile 10 fuel tank. The customer swipes his card through a card reader 12 on the fuel pump 14, the computer of which reads the data on the card, communicates with a database computer 16 to verify the status of the customer's account, and signals the fuel pump 14 to dispense fuel. The running total of fuel the consumer has on his account is preferably not accessed by the filling station's computer. Instead, the validity of the card is all that the filling station verifies before dispensing fuel. The customer then dispenses the ten gallons of fuel into his vehicle 10 as noted by the arrow in FIG. 1. This information about fuel dispensed is communicated to the account, preferably by the computer in the fuel pump card reader, and a transaction is carried out that leaves a 90 gallon balance on his account if the price of the fuel in the region dispensed is within X cents of the average for that area. If the price is higher, then the customer's account is reduced by a proportionately higher volume of fuel. If lower, the customer's account is reduced by a proportionately lower volume of fuel. In this manner, the customer's account is not affected by increases in the price of fuel that occur in all geographic areas, but it is affected by purchasing fuel in a region that has an average fuel cost that differs from the average fuel cost of the region in which he pre-purchased fuel.

In a preferred embodiment, the fuel pump 14 communicates with the computer 16 via the internet 20 using a wired or wireless connection. Alternatively, a direct communication connection can be made through the telephone system, either wired or wireless, or some other communication system.

The above process occurs regardless of whether the price of fuel is $3.00 per gallon (the pre-purchased price), $2.80 per gallon, $3.20 per gallon or any other price further from the pre-purchased price. If the price has increased $0.20 or some other amount per gallon since he or she purchased the fuel, the customer saved $0.20 per gallon by pre-purchasing the fuel in advance according to the invention. On the contrary, if the price per gallon of fuel decreased since the customer purchased the fuel, the customer loses $0.20 per gallon. The customer may pre-purchase additional fuel at the offered rate at any time. The customer can redeem/take delivery of the pre-purchased fuel at any time, regardless of the price at the pump, until his or her balance is depleted.

Two factors used in association with the method include (1) hedging the exposure to price fluctuation between the time of the pre-purchase and the time of the redemption at the pump and (2) properly setting the price of the pre-purchased fuel. The hedging process is a conventional method of hedging commodities to cover future obligations. The pre-purchase pricing provides real-time pricing unique to individual customers based on a number of factors, such as the customer's credit score, transaction history and other factors known to the person having ordinary skill.

There are a number of business models that may be implemented, including the use of annual membership fees, reload fees, and premium pricing for pre-purchases. The preferred embodiment uses a combination of a nominal annual fee, overdraft fees, a small reload fee, purchases of fuel at volume with discounts and competitive pricing of the fuel. In addition, post redemption adjustments may be made to accommodate for changes in fuel grades/types, regional price discrepancies resulting from travel, or extreme pricing at certain fueling establishments. Of course, other features will become apparent to the person having ordinary skill from the description herein.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method of a customer pre-purchasing goods from an entity at a first time and taking possession of the goods at a second, later time, the method comprising:
(a) the customer pre-purchasing the goods at the first time by transmitting a first consideration to the entity, wherein the first consideration is substantially equal to a value of the pre-purchased goods at the first time;
(b) the entity transmitting to the customer evidence of the pre-purchase;
(c) the customer presenting the evidence of the pre-purchase to a third party that possesses the goods, which evidence verifies the customer's right to the goods, and wherein the step of presenting the evidence occurs at the second time that is later than the first time;
(d) the third party verifying the evidence and permitting the customer to take possession of the goods;
(e) the customer taking physical possession of the goods; and
(f) the entity transmitting to the third party a second consideration for the goods of which the customer took possession, wherein the second consideration is substantially equal to a value of the goods, of which the customer took possession, at the second time.

2. The method in accordance with claim 1, wherein the step of transmitting evidence further comprises mailing to the customer a card having information thereon.

3. The method in accordance with claim 2, wherein the steps of presenting and verifying the evidence further comprise the customer entering the card's information to a computer and the computer communicating with a remote computer containing verification information.

4. The method in accordance with claim 1, wherein the step of transmitting evidence further comprises increasing a running total of goods pre-purchased by the customer in an account set up with the customer.

5. The method in accordance with claim 1, wherein the step of transmitting evidence further comprises communicating to the customer a unique password.

6. The method in accordance with claim 1, wherein the step of transmitting the second consideration further comprises the entity sending money to the third party.

7. A method of a customer pre-purchasing liquid fuel from an entity at a first time and taking possession of the goods at a second, later time at a fuel-dispensing facility, the method comprising:
(a) the customer pre-purchasing the fuel at the first time by transmitting a first amount of money to the entity, wherein the first amount of money is substantially equal to a value of the pre-purchased fuel at the first time;
(b) the entity transmitting to the customer evidence of the pre-purchase;
(c) the customer presenting the evidence of the pre-purchase to a third party that possesses the fuel at the fuel-dispensing facility, which evidence verifies the customer's right to the fuel, and wherein the step of presenting the evidence occurs at the second time that is later than the first time;
(d) the third party verifying the evidence and then permitting the customer to dispense the fuel;
(e) the customer dispensing the fuel into a fuel tank; and
(f) the entity transmitting to the third party a second amount of money related to the amount of fuel dispensed, wherein the second amount of money is substantially equal to a value of the dispensed fuel at the second time.

8. The method in accordance with claim 7, wherein the step of transmitting evidence further comprises mailing to the customer a card having machine-readable data thereon.

9. The method in accordance with claim 8, wherein the steps of presenting and verifying the evidence further comprise the customer displaying the card to a machine that is capable of reading the data thereon, and a computer to which the machine is connected communicating with a remote computer containing verification information.

10. The method in accordance with claim 7, wherein the step of transmitting evidence further comprises increasing a running total of goods pre-purchased by the customer in an account set up with the customer.

11. The method in accordance with claim 7, wherein the step of transmitting evidence further comprises transmitting to the customer a document that contains a unique identifier.

12. The method in accordance with claim 1, wherein the step of transmitting the second consideration further comprises the entity sending money to the third party.
